(19) United States
(12) Patent Application Publication
(10) Pub. No.: US 2002/0079468 A1
(43) Pub. Date: Jun. 27, 2002

(54) Autohandler and method for controlling the same

(75) Inventors: Hideki Takeuchi, Hamakita-shi (JP); Kazumi Okamoto, Hamakita-shi (JP)

Correspondence Address: OLIFF & BERRIDGE, PLC, P.O. BOX 19928, ALEXANDRIA, VA, 22320, US

(73) Assignee: Ando Electric Co., Ltd., Tokyo (JP)

(21) Appl. No.: 09/996,814

(22) Filed: Nov. 30, 2001

(30) Foreign Application Priority Data
Dec. 25, 2000 (JP) 2000-392810

(51) Int. Cl. G01N 21/86

(52) U.S. Cl. 250/559.4

(57) ABSTRACT

An autohandler for transporting a carrier which accommodates a plurality of electronic parts therein, to a test section to test electrical characteristics of the electronic parts. The autohandler comprises: a preheating section for heating or cooling the electronic parts to be tested, to a predetermined temperature; a test section for measuring electrical characteristics of the electronic parts which are heated or cooled, by electrically connecting each of the electronic parts to a testing device; a dry chamber for returning the temperature of tested electronic parts back to a normal temperature to prevent from generation of frost caused by a low temperature in the test section, and a part detecting section provided between the test section and dry chamber, for detecting whether each electronic part tested in the test section exists on a predetermined position for each electronic part to be accommodated, of the carrier.

### BACKGROUND OF THE INVENTION

1. Field of the Invention

The present invention relates to a parts handling device such as the so-called autohandler, for transporting a carrier which accommodates a plurality of parts, e.g., electronic parts, therein, to a test section to test the transported parts, and to a method for controlling the parts handling device.

2. Description of the Earlier Development

An autohandler is generally used for supplying fabricated electronic parts to a test system automatically to measure the electrical characteristics of the electronic parts, and for sorting the tested electronic parts automatically on the basis of the test results to store the sorted parts in different containers.

First, the structure of an autohandler according to an earlier development of the applicant will be explained as follows.

FIG. 9 shows a schematically plan view of the autohandler. Autohandler 40 has the function of testing the electronic parts under a high temperature or a low temperature. In the autohandler 40, a pluality of electronic parts 2 to be tested which are accommodated in a carrier 5 are moved in a circulating manner, as shown in this figure.

Autohandler 40 comprises a pre-heating section 402 for heating or cooling electronic parts 2 to be tested, to a set temperature, a test section 403 for measuring the electrical characteristics of electronic parts 2 which are at the set temperature, by pressing each of them against a testing device, and a dry chamber 404 for returning the temperature of tested electronic parts 2 back to the normal temperature to prevent frost generation caused by a low temperature in test section 403, as the testing function under a high temperature and a low temperature.

Autohandler 40 comprises a loading section 409 in which trays accommodating many fabricated electronic parts 2 are contained, a supply hand 407 for transporting electronic parts 2 from loading section 409 into containers 1 which are installed in a carrier 5, a supply section 401 for supplying carrier 5 to pre-heating section 402, a storing hand 408 for sorting tested electronic parts 2 to store them into an unloader 410, on the basis of the test results, and unloader 410 for storing sorted electronic parts 2. Autohandler 40 further comprises a control section for controlling the action of each of the above-described sections.

In autohandler 40, carrier 5 is circulated in the order of supply section 401, pre-heating section 402, test section 403, dry chamber 404, a buffer section 405, and an accommodating section 406, and then returns to supply section 401. In test section 403 of autohandler 40, an electronic part 2 accommodated in each container 1 is pressed down by a pusher and thereby the electric terminals of electronic part 2 which are provided on the rear surface thereof are brought into contact with terminals of a socket which are connected to an IC tester electrically. As a result, the electrical characteristics of electronic part 2 are measured.

However, after the electrical characteristics are measured, electronic part 2 often adheres to the lower surface of pusher 6 even after pusher 6 moves up, as shown in FIGS. 10A to 10C. Then, when pusher 6 holding electronic part 2 thereon further presses against an electronic part 2 accommodated in next container 1 for the next testing, electric terminals 21 of the next electronic part 2 often cannot be electrically connected to terminals 71 of socket 7 appropriately.

Even if electronic part 2 adhered on the lower surface of pusher 6 is not brought up to the next testing, electronic part 2 often falls down while pusher 6 is moving up after testing, and it often cannot return to the original position properly.

In the case of not returning to the original position properly, a plurality of electronic parts 2 may exist in a container. As a result, there is the problem of performing a wrong sorting at the accommodating section 406.

In particular, because recent BGA type of package of ICs are extremely light, the possibility of its adhering to pusher 6 is large. Therefore, an appropriate solution to the problem has been required.

### SUMMARY OF THE INVENTION

The present invention was developed in view of these problems. Therefore, an object of the invention is to provide an autohandler which is capable of reducing occurrence of errors on measurement or sorting, caused by adhesion of an electronic part to the pusher after testing.

In order to dissolve the above-described problems, according to one aspect of the invention, the autohandler for transporting a carrier which accommodates a plurality of parts therein, to a test section to test the parts, comprises: a part detecting member for detecting whether a tested part exists on a position to be accommodated for the part.

According to the autohandler having such a structure, after measurement by the test section, presence or absence of each of parts at a position to be accommodated can be detected. Therefore, if a part is not detected, it can be judged that the part to be accommodated at the position is adhered to the lower surface of a pusher of the test section or does not return to the original position properly after falling down from the pusher. Accordingly, it is possible to reduce occurrence of errors on measurement or sorting, caused by adhesion of an electronic part to the pusher after testing.

Preferably, the part detecting member may comprise: a light eradiating member for eradiating light into the position to be accommodated for the part, of the carrier, after the part is tested; and a photo-detector for detecting light eradiated from the light eradiating member or light reflected by a thing after eradiated, to detect whether the tested part exists on a position for the part to be accommodated, on the basis of strength of light received by the photo-detector.

In the autohandler having such a structure, the photo-detector disposed on the optical path of the light eradiating member detects presence or absence of light from the light eradiating member or light reflected by the part, or measures the strength of the light.

For example, when a part exists at a position to be accommodated on the carrier, the eradiated light is not detected by the photo-detector because of obstruction by the part. Therefore, it is possible to determine presence or absence of the part by the photo-detector to detect strength of the light eradiated from the light eradiating member. Further, because of a non-contact type detection, the autohandler also has the advantageous effect of no deterioration of moving members.

Further, the light eradiating member may be any device which emits light, e.g., a laser oscillator, a light emitting diode or the like; and the photo-detector may be any device which can obtain an output by receiving light, e.g., CCD element, photo-transistor or the like. Accordingly, it is possible to provide a detecting member at a low costs.

In the case of the manner of detecting the light reflected by the part, it is also-possible to determine presence or absence of the part by comparing the strength of light reflected from the part and the strength of light reflected from the container accommodating no parts therein.

Preferably, the part detecting member is disposed on a way of a transportation path of the carrier out of the test section.

In the autohandler having such a structure, the carrier passes through the part detecting member during transportation because of disposed on a way of a transportation path of the carrier out of the test section. As a result, it is also possible to detect presence or absence of the part without transportation of the carrier to a detecting member provided separately nor with stopping to detect, and thereby index time is not required.

Preferably, the plurality of parts are accommodated in the carrier and arranged in a plurality of columns in a direction along the transportation path of the carrier out of the test section, and the part detecting member is arranged on a plane including a portion of each path of the columns.

In the autohandler having such a structure, the parts are arranged in a plurality of columns on the carrier and the direction of each column is along the transportation path of the carrier. Each part detecting member is arranged at a position corresponding to each path of the columns. Accordingly, it is possible to detect presence or absence of the part in order every column in the carrier when the part passes through the corresponding part detecting member while the carrier is transported.

As a result, it is possible to test a large number of parts at a time and to detect presence or absence of the parts without increase of index time.

In the specification, the above-described part includes an electronic part such as an IC device, and the like.

In accordance with another aspect of the invention, the autohandler for transporting a carrier which accommodates a plurality of electronic parts therein, to a test section to test electrical characteristics of the electronic parts, comprises:

a pre-heating section for heating or cooling the electronic parts to be tested, to a predetermined temperature;

a test section for measuring electrical characteristics of the electronic parts which are heated or cooled, by electrically connecting each of the electronic parts to a testing device;

a dry chamber for returning the temperature of tested electronic parts back to a normal temperature to prevent from generation of frost caused by a low temperature in the test section; and

a part detecting section provided between the test section and dry chamber, for detecting whether each electronic part tested in the test section exists on a predetermined position for each electronic part to be accommodated, of the carrier.

According to the autohandler having such a structure, after measurement of the electrical characteristics of the electronic parts by the test section, presence or absence of each of parts at a position to be accommodated can be detected. Therefore, if an electronic part is not detected, it can be judged that the electronic part to be accommodated at the position is adhered to the lower surface of a pusher of the test section or does not return to the original position properly after falling down from the pusher. Accordingly, it is possible to reduce occurrence of errors on measurement or sorting, caused by adhesion of an electronic part to the pusher after testing.

Preferably, the plurality of electronic parts each of which is placed in a recess portion formed in approximately the center of a container, are accommodated on the carrier in a matrix of plural columns×plural rows so that each container is slightly movable on the carrier.

The recess portion formed in approximately the center of the container may be surrounded by a wall surface which is gradually inclined to enable placing the electronic part on the recess portion easily, and a through hole may be formed in the center of the recess portion so that electric terminals of electronic part placed on the recess portion can be brought into contact with electric terminals of socket through the through hole.

Each of the plural columns of electronic parts may be arranged in a direction along a transportation path of the carrier out of the test section, and a part detecting member may be arranged on a plane including a portion of each path of the columns.

The part detecting member may comprise one selected from the group consisting of: a pair of a light eradiating member and a photo-detector, a distance measuring sensor, and an image pick-up device.

In accordance with a further aspect of the invention, the method for controlling an autohandler for transporting a carrier which accommodates a plurality of electronic parts therein, to a test section to test the parts, the method comprises the steps of:

testing the electronic parts which are accommodated in the carrier;

detecting whether each of the tested electronic parts exists on each position for the part to be accommodated, after testing for the electronic parts accommodated in the carrier are completed; and

stopping the autohandler when no electronic parts exist on a position to be accommodated.

According to the method for controlling an autohandler, after measuring the electrical characteristics of each electronic part by the test section, presence or absence of each of parts at a position to be accommodated can be detected. Therefore, if an electronic part is not detected, it can be judged that the electronic part to be accommodated at the position is adhered to the lower surface of a pusher of the test section or does not return to the original position properly after falling down from the pusher. Accordingly, it is possible to reduce occurrence of errors on measurement or sorting, caused by adhesion of an electronic part to the pusher after testing.

In accordance with a further aspect of the invention, the method for controlling an autohandler for transporting a carrier which accommodates a plurality of parts therein, to a test section to test the parts, the method comprises the steps of:

heating or cooling the electronic parts to be tested, to a predetermined temperature;

measuring electrical characteristics of the electronic parts which are heated or cooled, by pressing electrical terminals of each of the electronic parts against electrical terminals of a-testing device to connect them electrically;

detecting whether each electronic part exists on a predetermined position for each electronic part to be accommodated, of the carrier, after the measuring electrical characteristics; and thereafter returning a temperature of the electronic parts back to a normal temperature to prevent generation of frost caused by a low temperature during the measuring electrical characteristics.

### BRIEF DESCRIPTION OF THE DRAWINGS

The present invention will become more fully understood from the detailed description given hereinbelow and the accompanying drawings which are given by way of illustration only, and thus are not intended as a definition of the limits of the present invention, and wherein;

FIG. 1 is a schematic plan view of a parts handling device according to an embodiment of the present invention;

FIG. 2A is a plan view showing an embodiment of a carrier used in the embodiment of the present invention, FIG. 2B is a front view thereof, and FIG. 2C is a side view thereof;

FIGS. 3A to 3C are vertical sectional views for explaining an embodiment of the testing step in the parts handling device of the present invention;

FIGS. 4A and 4B are vertical sectional views for explaining an embodiment of the part detecting member in the parts handling device of the present invention;

FIG. 5A is a schematic plan view for showing explaining an arrangement of the part detecting member in the parts handling device of the present invention, and FIG. 5B is a vertical sectional view thereof;

FIG. 6A is a schematic plan view for showing the state when presence or absence of an electronic part in each container in the first column of the parts on the carrier, and FIG. 6B is a vertical sectional view thereof;

FIG. 7A is a schematic plan view for showing the state when presence or absence of an electronic part in each container in the second column of the parts on the carrier, and FIG. 7B is a vertical sectional view thereof;

FIG. 8 is a flow chart showing the operation of the detecting member in the parts handling device;

FIG. 9 is a schematic plan view of a parts handling device according to an earlier development; and

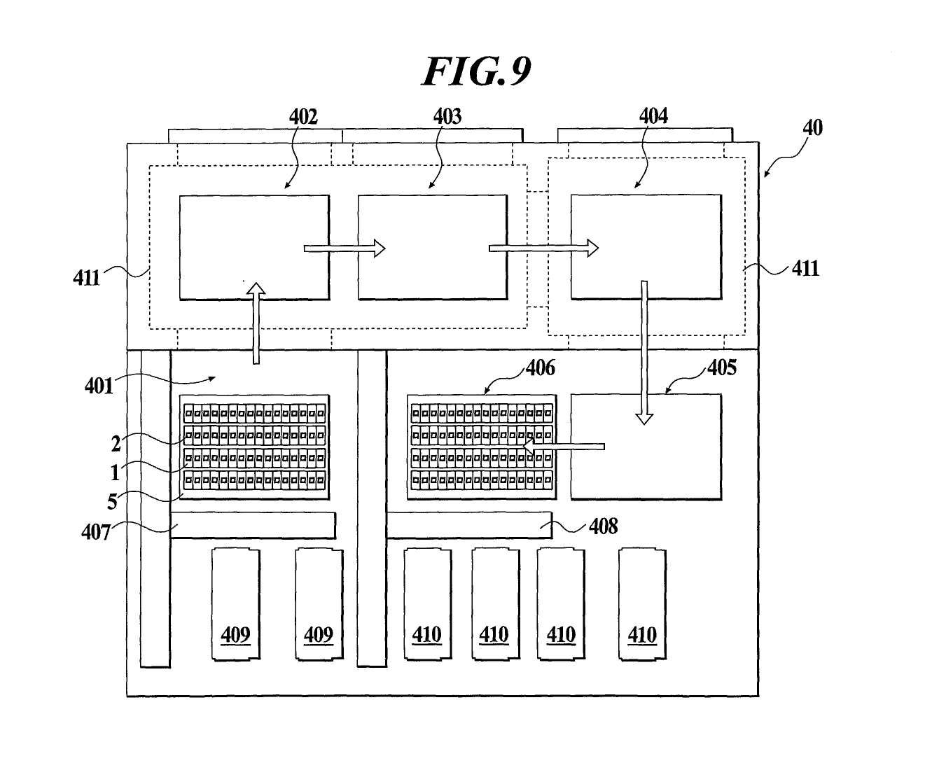

FIGS. 10A to 10C are vertical sectional views for explaining the state of an electronic part adhering to a pusher in the parts handling device.

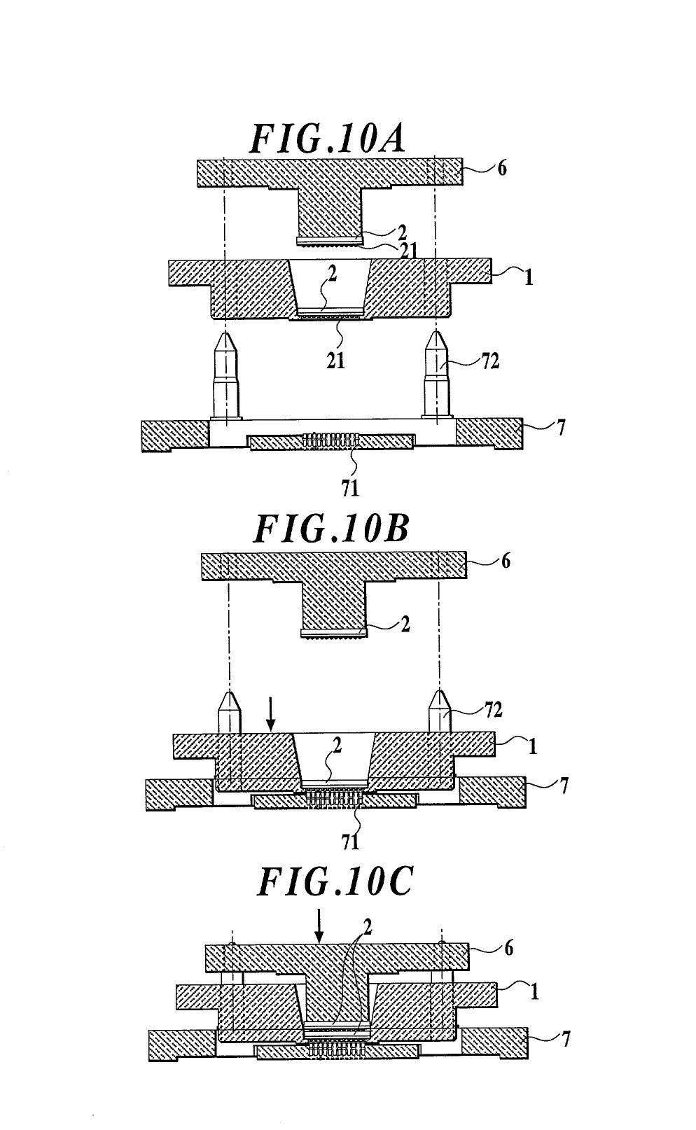

### DESCRIPTION OF PREFERRED EMBODIMENT

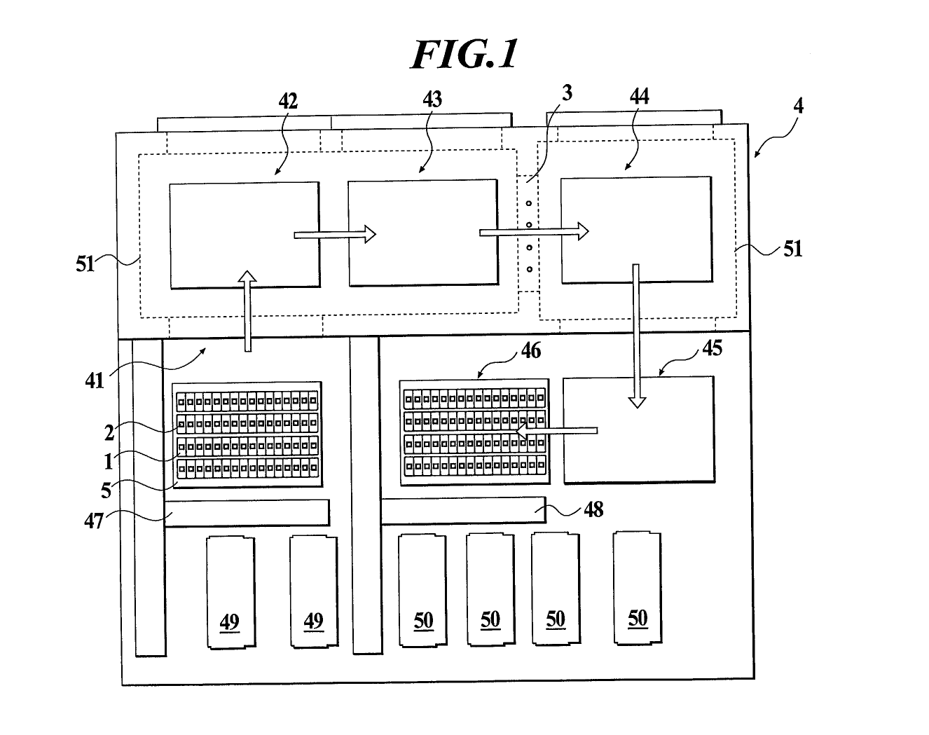

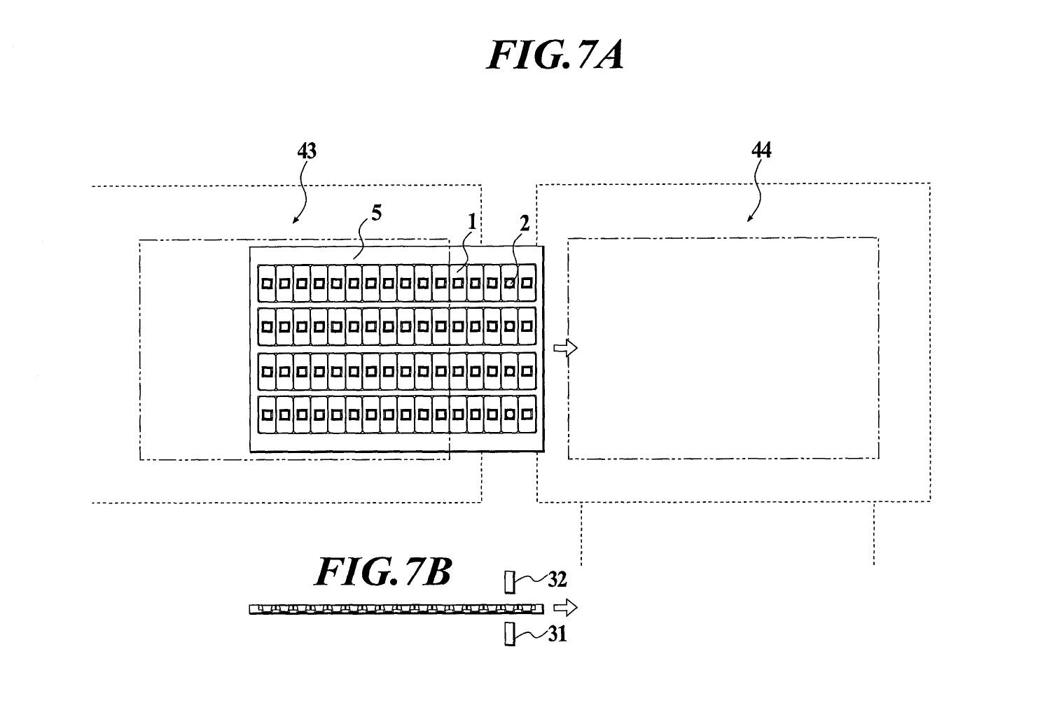

An embodiment of the parts handling device and a method for controlling the parts handling device, according to the present invention will be explained with reference to FIGS. 1 to 8, as follows.

FIG. 1 shows a parts handling device, i.e., an autohandler, according to an embodiment of the present invention.

The autohandler 4 has the function of testing electronic parts 2 under a high or low temperature. In autohandler 4, a pluality of electronic parts 2 to be tested which are accommodated in a carrier 5 are moved in a circulating manner, as shown in FIG. 1.

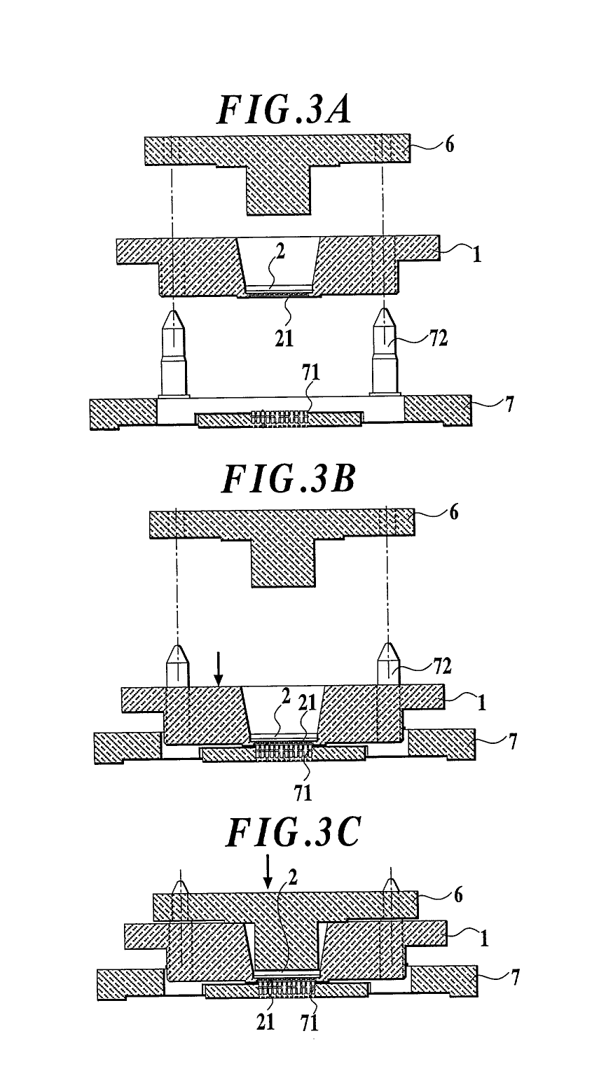

Autohandler 4 comprises a pre-heating section 42 for heating or cooling electronic parts 2 to be tested, to a set temperature; a test section 43 for measuring the electrical characteristics of electronic parts 2 which are at the set temperature, by pressing each of them against a socket 7, as shown in FIGS. 3A to 3C; a part detecting section 3 for detecting whether each tested part 2 exists on the predetermined position for the part to be accommodated, of carrier 5, after the part 2 is tested; and a dry chamber 44 for returning the temperature of tested electronic parts 2 back to-the normal temperature to remove the frost generated while being tested under a low temperature; as the testing function under a high or low temperature.

Autohandler 4 also comprises a loading section 49 in which trays accommodating many fabricated electronic parts 2 are contained, a supply hand 47 for transporting electronic parts 2 from loading section 49 into containers 1 which are installed in carrier 5, a supply section 41 for supplying carrier 5 to pre-heating section 42, a storing hand 48 for sorting tested electronic parts 2 to store them into an unloader 50, on the basis of the test results, and unloader 50 for storing sorted electronic parts 2. Autohandler 4 further comprises a built-in control section which is not shown, for controlling the above-described sections and the action thereof.

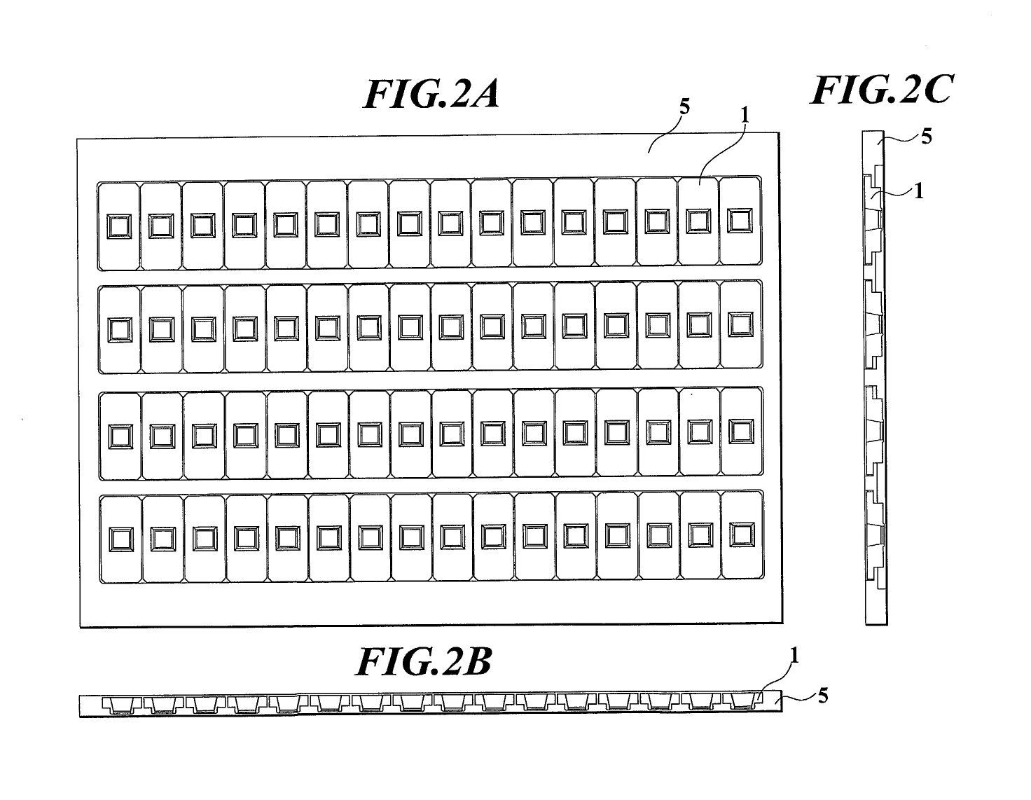

FIGS. 2A to 2C show carrier 5 in detail. Carrier 5 can accommodate a plurality of containers 1, for example, 64 containers in a matrix of 4 columns×16 rows in the figures. Each container 1 containing an electronic part 2 therein is placed in a recess portion formed in carrier 5 so that it is slightly movable in the recess portion. That is, carrier 5 shown in FIG. 2A can transport 64 electronic parts at a time.

In the center of each container 1, an approximate square recess portion for placing a square electronic part 2 is formed. The four wall surfaces surrounding the recess portion are gradually inclined to enable placing electronic part 2 on the recess portion easily. In the center of the recess portion, a through hole is formed so that electric terminals 21 of electronic part 2 placed on the recess portion can be brought into contact with electric terminals 71 of socket 7 through the through hole, as shown in FIG. 3C.

Test section 43 comprises socket 7 having electric terminals 71 which can be electrically connected to electric terminals 21 of electronic part 2, a pusher 6 for pressing down electronic part 2 to connect electric terminals 21 of electronic part 2 to electric terminals 71 of socket 7, and an IC tester (not shown) connecting to electric terminals 71, as shown in FIGS. 3A to 3C.

In test section 43, electronic part 2 is brought into contact with socket 7 by using the pusher 6 and is tested by the IC tester. Test section 43 judges the characteristics of electronic part 2 on the basis of the test results. The number of the sockets or the pushers which are provided in test section 43 is the same as the number of electronic part 2 accommodated in carrier 5. Accordingly, test section 43 can test all electronic part 2 accommodated in carrier 5 at a time.

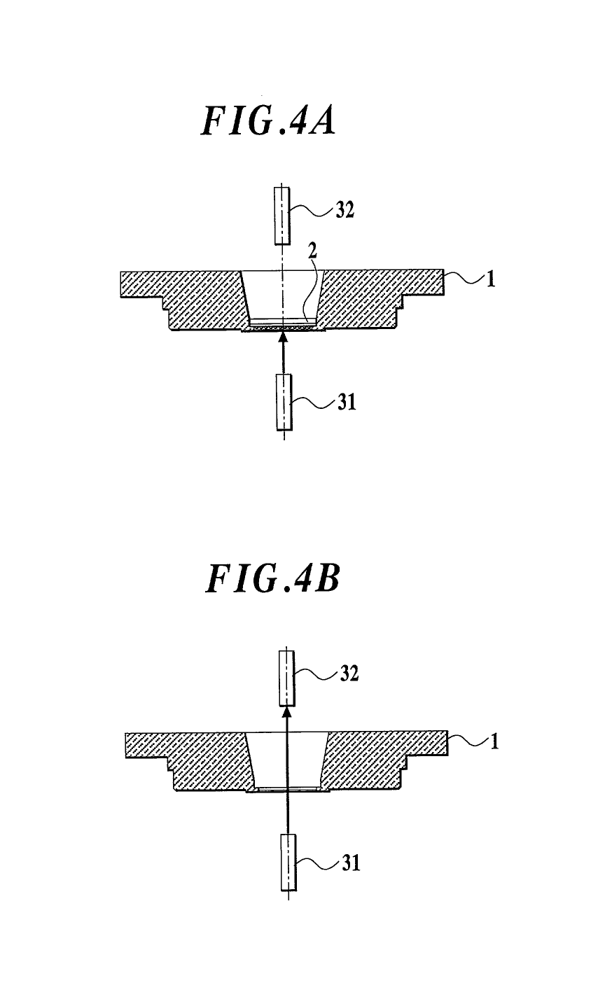

Part detecting section 3 comprises a plurality of optically detecting members. Each detecting member comprises a light eradiating member 31 for eradiating light into the position for electronic part 2 to be accommodated, of container 1, and a photo-detector 32 for detecting light eradiated from light eradiating member 31, as shown in FIGS. 4A and 4B.

The number of pairs of detecting members 3 is the same as that of the columns of electronic parts 2 in the containers 1 on a carrier 5. The number of pairs of detecting members 3 is four in this embodiment of FIG. 1. Each pair of detecting members 3 is on a plane including the line which is formed by connecting the center of the through holes of containers 1 in each column on carrier 5. That is, when carrier 5 having electronic parts 2 of four columns, each of which is set in a container 1 passes through detecting section 3, the light from light eradiating member 31 is eradiated to every electronic part 2 on carrier 5, as shown in FIGS. 4A and 4B.

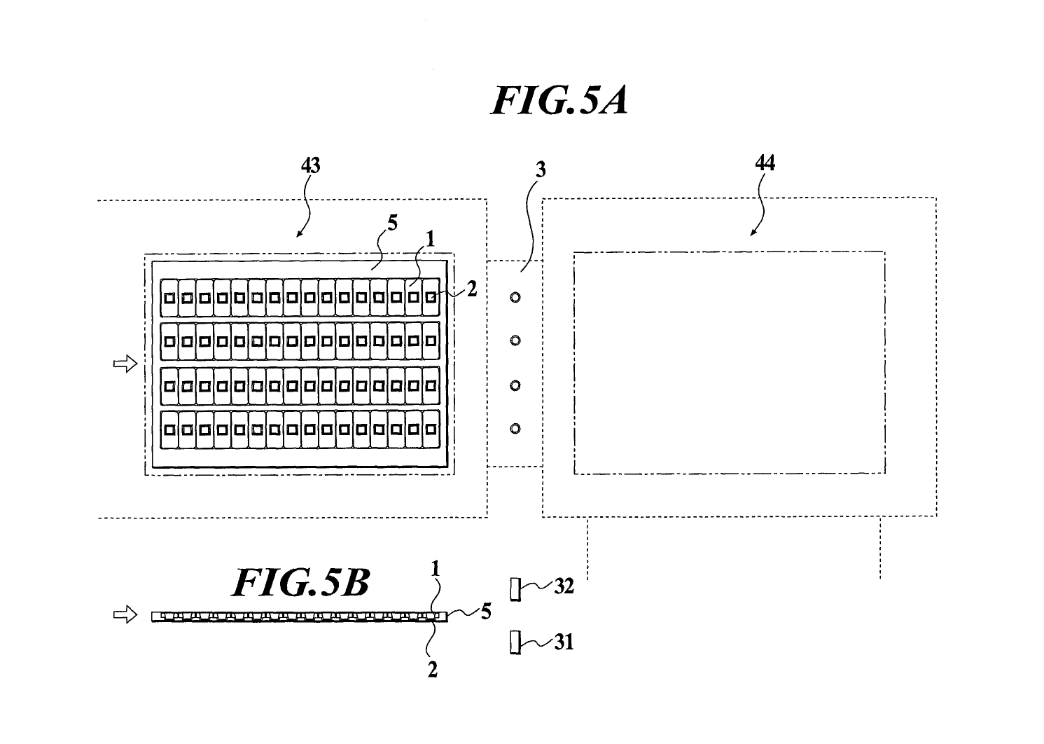

Light eradiating member 31 and photo-detector 32 of each detecting member 3 are arranged up and down opposite to each other on the optical axis of light eradiating member 31 so that carrier 5 having electronic parts 2 can pass through between light eradiating member 31 and photo-detector 32, as shown in FIGS. 5A and 5B. The four pairs of detecting members 3 are arranged in a direction perpendicular to the transportation path of carrier 5 which goes from test section 43 to dry chamber 44.

Hereinafter, light eradiating member 31 may be any device which emits light, e.g., a laser oscillator. A light emitting diode or the like is preferable as the light eradiating member because of its high durability and being not expensive. Photo-detector 32 may be any device which can obtain an output by receiving light, e.g., CCD element, photo-transistor or the like. A cheap photosensitive element can be also used as the photo-detector because only an output for detecting whether light is received or not is sufficient.

The above-described control section controls each of the above-described sections and comprises a CPU for processing, a RAM for storing various types of data with respect to operational control, the detection results with respect to presence or absence of electronic parts 2 and the like, a CRT for providing various types of display, and the like.

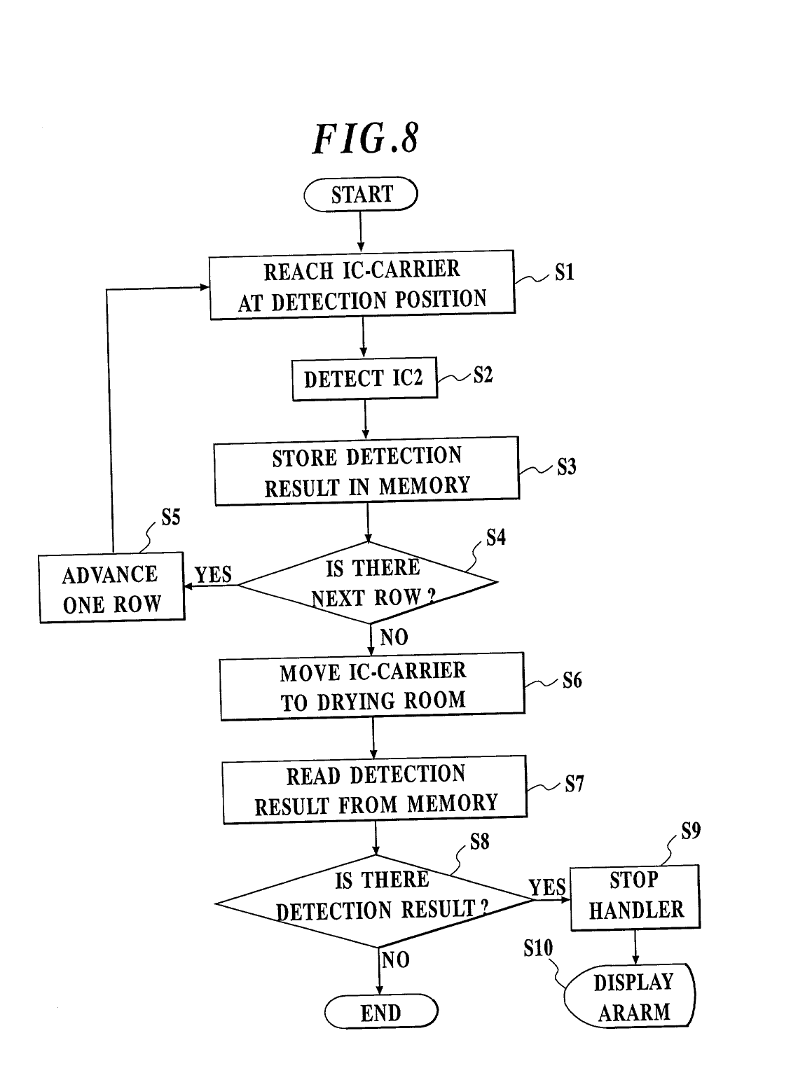

Next, the operation of the autohandler 4 will be explained with reference to FIG. 8, as follows.

The supply hand 47 transports a plurality of electronic parts 2 accommodated in the loader 49 into carrier 5 of the supply section 41, one by one. Carrier 5 which becomes full of electronic parts 2 is transported to the pre-heater section 42.

When the temperature of electronic parts 2 reaches a set temperature (a high or low temperature) in the pre-heater section 42, carrier 5 is moved to test section 43.

In test section 43, carrier 5 with electronic parts 2 is moved to a position just above the sockets 7, as shown in FIG. 3A. Then, carrier 5 is moved down on the sockets 7 so that each container having an electronic part 2 is brought into contact with the corresponding socket 7 by a lifting mechanism. During moving down of carrier 5, electronic parts 2 are introduced to right positions by fitting positioning pins 72 provided on the sockets 7 into holes formed in containers 1, as shown in FIG. 3B. Next, pushers 6 are moved down by a lifting mechanism to press down the corresponding electronic parts 2 toward the sockets 7. Accordingly, electric terminals 21 of each electronic part 2 are brought into contact with electric terminals 71 of each socket 7, as shown in FIG. 3C. Thereafter, the electrical characteristics of each electronic part 2 are measured by the IC tester which is not shown.

After the measurement is completed, the pushers 6 and carrier 5 are moved up to the original position to finish the operation of test section 43.

If an electronic part 2 is adhered to the lower surface of the pusher 6 when the measurement is finished, no electronic part 2 exist on the container for the part. As a result, carrier 5 are transported in a state of being not full of electronic parts 2, to the dry chamber 44.

On a way of the transportation path of carrier 5 between test section 43 and the dry chamber 44, the part detecting section 3 is provided.

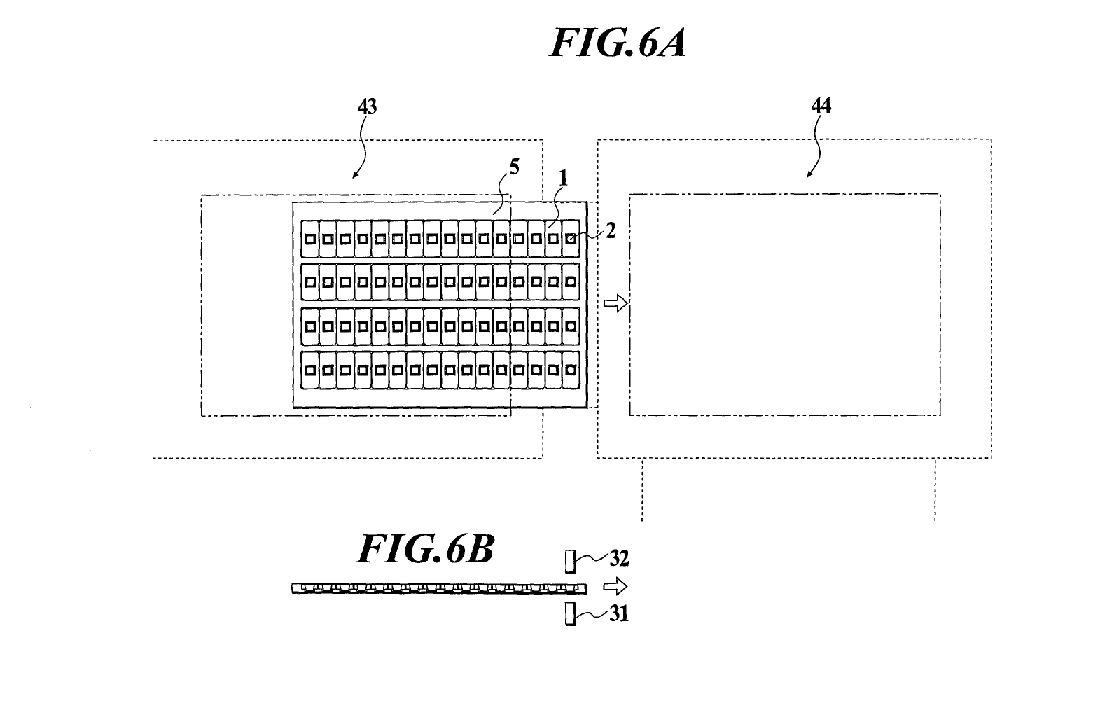

When the IC carrier 5 reaches the part detecting section 3 (S1) and the four containers 1 of the first row thereon come to the position just above four light eradiating members 31, as shown in FIGS. 6A and 6B, light from the four light eradiating members 31 are eradiated to the electronic parts 2 set in the four containers 1 of the first row. At this time, when an electronic part 2 is accommodated in the container 1, the light from the corresponding light eradiating members 31 is interrupted by the electronic part 2 and therefore the corresponding photo-detector 32 detects no light. On the contrary, when photo-detector 32 detects light from the light eradiating members 31, that is, when photo-detector 32 detects light having a strength larger than a predetermined level, no electronic parts 2 must be accommodated in the corresponding container 1 after testing, for some reason. Therefore, presence or absence of the electronic part 2 in the container 1 after testing can be detected on the basis of the measurement results of photo-detector 32 (S2). The information of the detection results are stored in the RAM in the control section (S3).

Then, when another row to which no detection step is performed yet exists in the carrier 5 (S4), the carrier 5 is advanced by one row (S5) and similar detection with respect to presence or absence of the electronic parts 2 in the four containers 1 of the row are carried out (S1-S3). Similarly, such detection are carried out for every container on the carrier 5.

When another row to which no detection step is performed yet does not exist in the carrier 5 (S4), the carrier 5 is passed through the part detecting section 3 and is transported to the dry chamber 44 (S6). At this time, the control section reads the detection results from the RAM (S7). When light was received by photo-detector 32 during the detection step, that is, detection of light is included in the detection results (S8), autohandler 4 is stopped once (S9) to display an alarm (S10). When no detection of light are included in the detection results (S8), autohandler 4 judges that an electronic part 2 exists at the right position in every container 1 on the carrier 5. In this case, the test operation for the next carrier 5 is proceeded in the test section 43.

In the dry chamber 44, the carrier 5 is heated to prevent from frost generation caused by low temperature. Thereafter, the carrier 5 is transported to the buffer section 45 and to the accommodating section 46.

In the accommodating section 46, storing hand 48 sorts the tested electronic parts 2 accommodated in the carrier 5 in order on the basis of the test results and stores them into unloader 50.

Carrier 5 which becomes empty at accommodating section 46 is moved to supply section 41. As described above, in autohandler 4, carrier 5 is circulated in the order of supply section 41, pre-heating section 42, test section 43, dry chamber 44, a buffer section 45, accommodating section 46, and supply section 41.

In the above-described embodiment, although the detecting member for detecting presence or absence of electronic parts 2 comprises a light eradiating member 31 and a photo-detector 32, the present invention is not limited by the structure. For example, it is possible to use a distance measuring sensor as the detecting member. In this case, presence or absence of electronic parts 2 can be detected from the difference of distances. It is also possible to use an image pick-up device, e.g., CCD camera or the like, as the detecting member. In this case, presence or absence of electronic parts 2 can be detected from the difference between extracted outlines of electronic parts 2 and of no electronic parts 2, or from the difference between the surface colors of electronic parts 2 and of no electronic parts 2.

The relationship between light eradiating members 31 and photo-detectors 32 does not necessarily require a one-to-one correspondence. For example, the detection section 3 may comprise a long light emitting member 31 like a line sensor or the like, and a plurality of photo-detectors 32 each of which is disposed at a respective predetermined position corresponding to each position of accommodated electronic parts 2 in a row and can receive light from the long light emitting member 31. Further, the arrangement position, the set direction of optical axis, the number, and the like of detecting member 3 can be changed appropriately.

The entire disclosure of Japanese Patent Application No. Tokugan 2000-392810 filed on Dec. 25, 2000 including specification, claims, drawings and summary are incorporated herein by reference in its entirety.

What is claimed is:

1. An autohandler for transporting a carrier which accommodates a plurality of parts therein, to a test section to test the parts, comprising:
a part detecting member for detecting whether a tested part exists on a position to be accommodated for the part.

2. The autohandler as claimed in claim 1, wherein the part detecting member comprises:
a light eradiating member for eradiating light into the position to be accommodated for the part, of the carrier, after the part is tested; and
a photo-detector for detecting light eradiated from the light eradiating member or light reflected by a thing after eradiated, to detect whether the tested part exists on a position for the part to be accommodated, on the basis of strength of light received by the photo-detector.

3. The autohandler as claimed in claim 1 or 2, wherein the light eradiating member comprises a laser oscillator or a light emitting diode; the photo-detector comprises a CCD element or a photo-transistor.

4. The autohandler as claimed in claim 1 or 2, wherein the part detecting member is disposed on a way of a transportation path of the carrier out of the test section.

5. The autohandler as claimed in claim 4, wherein the plurality of parts are accommodated in the carrier and arranged in a plurality of columns in a direction along the transportation path of the carrier out of the test section, and the part detecting member is arranged on a plane including a portion of each path of the columns.

6. An autohandler for transporting a carrier which accommodates a plurality of electronic parts therein, to a test section to test electrical characteristics of the electronic parts, comprising:
a pre-heating section for heating or cooling the electronic parts to be tested, to a predetermined temperature;
a test section for measuring electrical characteristics of the electronic parts which are heated or cooled, by electrically connecting each of the electronic parts to a testing device;
a dry chamber for returning the temperature of tested electronic parts back to a normal temperature to prevent from generation of frost caused by a low temperature in the test section, and
a part detecting section provided between the test section and dry chamber, for detecting whether each electronic part tested in the test section exists on a predetermined position for each electronic part to be accommodated, of the carrier.

7. The autohandler as claimed in claim 6, wherein the plurality of electronic parts each of which is placed in a recess portion formed in approximately the center of a container, are accommodated on the carrier in a matrix of plural columns×plural rows so that each container is slightly movable on the carrier.

8. The autohandler as claimed in claim 7, wherein the recess portion formed in approximately the center of the container is surrounded by a wall surface which is gradually inclined to enable placing the electronic part on the recess portion easily, and a through hole is formed in the center of the recess portion so that electric terminals of electronic part placed on the recess portion can be brought into contact with electric terminals of socket through the through hole.

9. The autohandler as claimed in claim 7, wherein each of the plural columns of electronic parts is arranged in a direction along a transportation path of the carrier out of the test section, and a part detecting member is arranged on a plane including a portion of each path of the columns.

10. The autohandler as claimed in claim 7, wherein the part detecting member comprises one selected from the group consisting of: a pair of a light eradiating member and a photo-detector, a distance measuring sensor, and an image pick-up device.

11. A method for controlling an autohandler for transporting a carrier which accommodates a plurality of electronic parts therein, to a test section to test the parts, the method comprising the steps of:
testing the electronic parts which are accommodated in the carrier;
detecting whether each of the tested electronic parts exists on each position for the part to be accommodated, after testing for the electronic parts accommodated in the carrier are completed; and
stopping the autohandler when no electronic parts exist on a position to be accommodated.

12. A method for controlling an autohandler for transporting a carrier which accommodates a plurality of parts therein, to a test section to test the parts, the method comprising the steps of:
heating or cooling the electronic parts to be tested, to a predetermined temperature;
measuring electrical characteristics of the electronic parts which are heated or cooled, by pressing electrical terminals of each of the electronic parts against electrical terminals of a testing device to connect them electrically;
detecting whether each electronic part exists on a predetermined position for each electronic part to be accommodated, of the carrier, after the measuring electrical characteristics; and thereafter
returning a temperature of the electronic parts back to a normal temperature to prevent generation of frost caused by a low temperature during the measuring electrical characteristics.
